(19) United States
(12) Patent Application Publication
(10) Pub. No.: US 2010/0193140 A1
(43) Pub. Date: Aug. 5, 2010

(54) ROTARY EVAPORATOR

(75) Inventor: Joachim Carl, Stein (DE)

Correspondence Address: GIFFORD, KRASS, SPRINKLE,ANDERSON & CITKOWSKI, P.C, PO BOX 7021, TROY, MI, 48007-7021, US

(73) Assignee: HANS HEIDOLPH GmbH & Co. KG, Kelheim (DE)

(21) Appl. No.: 12/695,550

(22) Filed: Jan. 28, 2010

(30) Foreign Application Priority Data
Jan. 30, 2009 (DE) DE102009006816.3

(51) Int. Cl. B01D 1/22; B01L 9/00

(52) U.S. Cl. 159/11.1; 422/104

(57) ABSTRACT

The invention relates to a rotary evaporator having an apparatus for the securing of a ground joint including a ground sleeve and a ground core between an evaporator flask and a steam leadthrough, wherein the securing device has a fastening section at the ground core side and a snap connector at the ground sleeve side and pivotably supported at the fastening section at the ground sleeve side between a release position and a holding position in order selectively to release or firmly hold the piece of laboratory equipment at the ground sleeve side.

### CROSS-REFERENCE TO RELATED APPLICATION

This application claims priority of German Patent Application DE 102009006816.3 filed Jan. 30, 2009.

### FIELD OF THE INVENTION

The present application relates to a rotary evaporator having an apparatus for the securing of a ground joint, in particular a ground glass joint, including a ground core between an evaporator flask and a steam leadthrough.

### BACKGROUND OF THE INVENTION

A rotary evaporator is a piece of laboratory equipment which includes a heating bath and an evaporator flask which can dip into the heating bath. In operation, a liquid medium present in the heating bath, for example water or—for higher temperatures—oil, is heated in order thus to heat the evaporator flask dipped into the heating bath. A liquid mixture contained in the evaporator flask can hereby be heated so that the respective distillate, in particular solvent, is evaporated. The evaporated distillate then flows into a cooler of the rotary evaporator to condense there. The condensate is subsequently collected in a collection flask. The distillation residue remaining in the evaporator flask can be further processed or analyzed. A vacuum pump is frequently additionally provided for the generation of a vacuum in the evaporator flask and in the cooler to lower the boiling point, whereby the distillation can be accelerated and the distillation rate can be increased.

A rotary evaporator furthermore includes a rotary drive for the rotation of the evaporator flask in the heating bath. The evaporator flask is uniformly heated due to the rotation and a thin liquid film, which has a large surface and from which the distillate can be evaporated fast, efficiently and gently, is produced at the heated inner wall of the evaporator flask.

In order to set the rotary damper into rotation which is, for example, rotationally fixedly connected to the initially named steam leadthrough via a ground joint, the steam leadthrough, which is usually formed as a hollow glass shaft and which serves to conduct the evaporated distillate from the evaporator flask to the cooler, is rotatingly driven by the rotary drive. Such a ground joint is usually secured using a Keck clamp.

With a Keck clamp, two respective snap connectors of part ring shape which extend in two planes parallel to one another are connected via a plurality of webs. To secure the ground joint, the Keck clamp is placed on such that the one of the two snap connectors engagingly surrounds the ground sleeve of the evaporator flask behind a flanged rim of the ground sleeve and the other of the two snap connectors engagingly surrounds the ground core of the steam lead through behind a collar adjoining the ground core.

A widening of the one snap connector also directly results in a widening of the other snap connector due to the web coupling. This is a disadvantage when the section of the ground joint engaged around either at the ground sleeve side or at the ground core side has a larger outer diameter than expected, as is frequently the case due to deviations in the production of glass devices. It can, for example, occur that the ground sleeve of the evaporator flask has too large an outer diameter at the engaged around section, whereby the snap connector at the ground sleeve side is widened accordingly and then also the snap connector at the ground core side via the web coupling. In the extreme case, the widening can be so wide that with a loose ground joint the snap connector at the ground core side can slip over the collar and thus the evaporator flask can slip from the steam leadthrough.

### SUMMARY OF THE INVENTION

It is the underlying object of the invention to provide a rotary evaporator of the initially named kind which can ensure a reliable securing of a ground joint.

This object is satisfied by a rotary evaporator having the features of claim 1 and in particular in that the securing apparatus has a fastening section at the ground core side and a snap connector at the ground sleeve side and pivotably supported at the fastening section between a release position and a holding position in order selectively to release or firmly hold the piece of laboratory equipment, in particular the evaporator flask, at the ground sleeve side.

The fastening section can be fastened or mounted—in particular without forming a snap connection—to a component through which the piece of laboratory equipment, in particular the steam leadthrough, at the ground core side can be guided, in particular to a clamping member for the clamping of a clamping insert for the clamping of the steam leadthrough in a hub of a rotary drive of the rotary evaporator, or directly to the piece of laboratory equipment at the ground core side. The fastening section is preferably made in ring shape, in particular in closed ring shape.

At the ground sleeve side, in contrast, a snap connector supported at the fastening section is provided. The in particular hoop-like snap connector is pivotable between a release position and a holding position. In the release position, the piece of laboratory equipment, in particular the evaporator flask, at the ground sleeve side is released from the snap connector. In the holding position, the snap connector is snapped onto the ground sleeve of the piece of laboratory equipment at the ground sleeve side, i.e. the piece of laboratory equipment at the ground sleeve side is held by the snap connector, in particular by form fitting.

The apparatus in accordance with the invention satisfies its securing function independently of a diameter variation of the neck of the piece of laboratory equipment, in particular of the evaporator flask, at the ground sleeve side. The piece of laboratory equipment at the ground sleeve side can—in particular independently of the position of the fastening section at the aforesaid component—be firmly held by the securing apparatus for as long as the snap connector is in the holding position.

In contrast to a Keck clamp, the securing apparatus in accordance with the invention only has one snap connector. A deformation of the snap connector at the ground sleeve side in particular has no return effect on the fastening and/or on the shape of the fastening section at the ground core side.

In accordance with an embodiment of the invention, the fastening section is formed as a ring nut, in particular having an internal thread. The ring nut can in particular be able to be screwed onto an external thread of the aforesaid component or of the piece of laboratory equipment at the ground core side. A ring nut ensures a fastening of the securing apparatus which can be established fast and simply. The ring nut can furthermore also be held in a manner secure against losing in the release position of the snap container, for example at the aforesaid component.

The snap connector can have only one pivot arm to which the snap connector is pivotally connected at the fastening section. The snap connector, however, preferably has two pivot arms for a particularly stable and robust connection, said two pivot arms each being pivotally connected to the fastening section from two sides of the fastening section which are mutually opposite, in particular mutually diametrically opposite.

The snap connector in particular includes a holding section which is adapted to engage behind a flanged rim of a piece of laboratory equipment at the ground sleeve side in the holding position of the snap connector. To enable a snap connection between the snap connector and a piece of laboratory equipment at the ground sleeve side, it is preferred if the holding section of the snap connector is formed in part ring shape with a circle arc extending over more than 180°. The holding section is preferably designed spring elastically deformably.

The holding section can define a plane which extends at least substantially perpendicular to a longitudinal axis and/or to an axis of rotation of the fastener section in the holding position of the snap connector. In the holding position, the aforesaid pivot arms can extend parallel to the aforesaid longitudinal axis and/or axis of rotation of the fastening section.

In accordance with another embodiment of the invention, the fastening section is centrally passed through by the pivot axis of the snap connector. A securing apparatus can be provided by the central pivotal connection of the snap connector to the fastening section which has a particularly compact form both in the release position of the snap connector and in the holding position.

The pivot range of the snap connector preferably has a value between 60° and 120°. The aforesaid value is particularly preferably at least substantially 90°. The pivot range limits are preferably each preset by an abutment.

In accordance with a further embodiment of the invention, the fastening section has a press-off section and/or a press-off mechanism by which the piece of laboratory equipment at the ground sleeve side can be pressed off the piece of laboratory equipment at the ground core side. This is in particular of advantage when the ground joint is jammed and can no longer be released in a different manner.

To be able to easily actuate the fastening section, in particular to facilitate a screwing onto an external thread, a gripping corrugation is provided at the outer surface of the fastening section.

The fastening section and the snap connector are preferably each formed in one piece and/or from plastic.

A clamping member for the clamping of a clamping insert for the clamping of the steam leadthrough in a hub of the rotary drive of the rotary evaporator can be provided, with the securing apparatus being fastenable to the clamping member and the clamping member being fastenable to a rotary drive of the rotary evaporator.

The clamping member is in particular formed as a clamping ring nut having an internal thread, with the clamping ring nut being able to be screwed onto the hub of the rotary drive.

The invention furthermore relates to an apparatus for the securing of a ground joint including a ground sleeve and a ground core between two piece of laboratory equipment, in particular between an evaporator flask and a steam leadthrough of a rotary evaporator, with the securing apparatus having a fastening section at the ground core side and a snap connector at the ground sleeve side pivotally supported at the fastening section between a release position and a holding position in order selectively to release or firmly hold the piece of laboratory equipment at the ground sleeve side.

Advantageous further developments of the securing apparatus in accordance with the invention result in an analog manner from the further developments described above with respect to the rotary evaporator in accordance with the invention.

Advantageous embodiments of the invention are also set forth in the dependent claims, in the description of the Figures and in the drawing.

### BRIEF DESCRIPTION OF THE DRAWINGS

The invention will be described in the following by way of example with reference to the drawing. There are shown, schematically in each case:

FIG. 1 a perspective view of a rotary evaporator;

FIG. 2a a part cross-section along a longitudinal axis of a hub of a rotary drive of a rotary evaporator having an inserted clamping sleeve and an inserted steam leadthrough as well as a ground joint and an evaporator flask;

FIG. 2b an enlarged detail of the region A from FIG. 2a;

FIG. 3 a perspective view of the clamping sleeve of FIG. 2a;

FIG. 4 the hub of FIG. 2a in an enlarged individual representation;

FIG. 5 a perspective view of the ground clamp of FIG. 2a in a holding position; and

FIG. 6 a perspective view of the ground clamp of FIG. 2a in a release position.

### DETAILED DESCRIPTION OF THE PREFERRED EMBODIMENTS

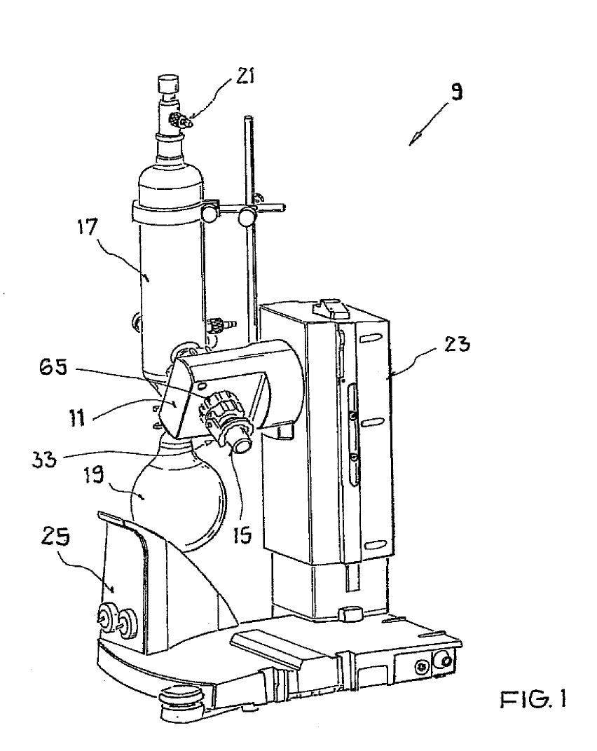

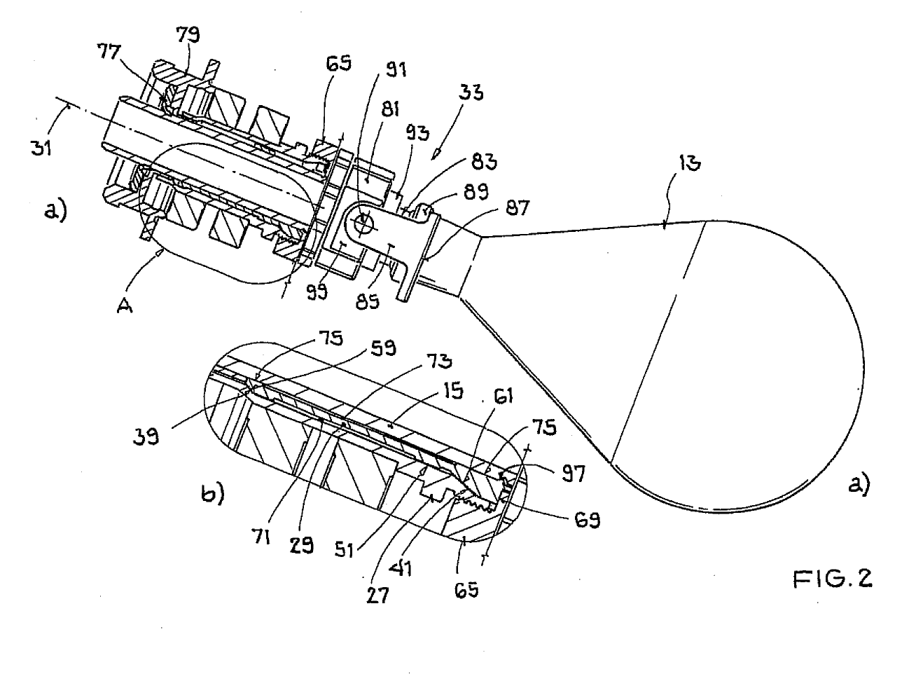

The rotary evaporator 9 shown in FIG. 1 includes a rotary drive 11 for an evaporator flask 13, in particular of glass, which is shown only in FIG. 2 and is designed as a round bottomed flask or a V-shaped flask or the like and which can be heated in a heating bath, not shown, to evaporate distillate from a liquid mixture present therein. The evaporated distillate then moves via a steam leadthrough 15, in particular formed as a hollow glass shaft, which is guided through the rotary drive 11 and of which only a ground core projecting obliquely downwardly from the rotary drive 11 can be recognized in FIG. 1 into a cooler 17 to condensate there. The condensed distillate is then collected in a collection flask 19.

A vacuum connection 21 is provided at the cooler 17 to apply a vacuum generated by a vacuum pump at the cooler 17 and at the evaporator flask 13, whereby the boiling point for the distillate can be lowered. The rotary evaporator 9 additionally includes a lift 23 which carries the rotary drive 11 and can move it in the vertical direction to lower the evaporator flask 13 into the heating bath or to lift it out of it. The rotary evaporate 9 furthermore includes an operating unit 25 for the control of the heating bath, of the rotary drive 11, of the vacuum pump and of the lift 23.

The steam leadthrough 15 is pushed through a hub 27 of the rotary drive 11 (FIG. 2) and is clamped in the hub 27 via a clamping sleeve 29 which is located between the hub 27 and the steam leadthrough 15 so that a rotation of the hub 27 of the rotary drive 11 about a longitudinal axis 31 of the hub 27 results in a corresponding rotation of the clamping sleeve 29, of the steam leadthrough 15 and of the evaporator flask 13 rotationally fixedly connected to the stream leadthrough 15. The longitudinal axis 31 is in this respect—in the assembled state of the rotary evaporator 9—a common longitudinal axis 31 of the hub 27, of the clamping sleeve 29, of the steam leadthrough 15 and of the evaporator flask 13. The hub 27, the clamping sleeve 29 and the steam leadthrough 15 are arranged concentrically to one another.

The rotationally fixed connection between the steam leadthrough 15 and the evaporator flask 13 is ensured by a ground joint, in particular a conical ground joint, in which the steam leadthrough 15 engages with its side which faces the evaporator flask 13 and at which a ground core is formed into a ground sleeve formed at a flask neck of the evaporator flask 13. A ground clamp 33 is provided to secure the ground joint, in particular formed as a ground glass joint, between the steam leadthrough 15 and the evaporator flask 13.

The clamping sleeve 29 having rotational symmetry, in particular three-fold rotational symmetry, and comprising plastic includes in accordance with FIG. 3 a front axial end 35 and a rear axial end 37. The clamping sleeve 29 is inserted front end 35 first into the hub 27 of the rotary drive 11 of the rotary evaporator 9. Directly adjoining the front end 35, the clamping sleeve 29 has a front clamping section 39 whose outer diameter expands conically to the rear. A further such rear clamping section 41 is provided in the rear region of the clamping sleeve 29 and its maximum outer diameter is larger than the maximum outer diameter of the front clamping section 39. Since the inner diameter of the clamping sleeve 29 is constant in each case in the region of the clamping sections 39, 41, the wall thickness of the clamping sleeve 29 increases accordingly in the region of the clamping sections 39, 41.

The clamping sleeve 29 has in each case at its two ends 35, 37 three elongate incisions or openings 43 open toward the respective end 35, 37, with the respective openings 43 being provided distributed equally in the peripheral direction of the clamping sleeve 29 at each of the two sides 35, 37. An opening 43 of the first end 35 and an opening of the second end 37 are in each case arranged along a straight line parallel to the longitudinal axis 31′ of the clamping sleeve 29.

The respective opening 43 extends in the longitudinal direction 31′ of the clamping sleeve 29 and, coming from the respective end 35, 37, beyond the first or second clamping sections 39, 41 respectively. Each of the two clamping sections 39, 41 is hereby divided into three clamping segments 45 of part ring shape which are arranged along a circular line extending concentrically to the longitudinal axis 31′ of the clamping sleeve 29.

Expressed differently, the clamping sleeve 29 is divided into three longitudinal sections of part sleeve shape which together form the sleeve-like basic shape of the clamping sleeve 29 and are held fixedly to one another via connection webs 95 extending in the peripheral direction. A respective one of the connection webs 95 is arranged between a respective two of the longitudinal sections of part sleeve shape, with the connection webs 95 being arranged at the same level viewed in the longitudinal direction of the clamping sleeve 29.

A middle section 47 of the clamping sleeve 29 is arranged between the two clamping sections 39, 41. The middle section 47 includes a cylindrical recess 49 and two ring webs 51 which bound the recess 49 in the longitudinal direction 31′ of the clamping sleeve 29, extend in the peripheral direction, project radially outwardly and are, however, interrupted by the openings 43. The two ring webs 51 each have a constant outer diameter which is the same.

A further such rear ring web 53 is furthermore provided between the rear clamping section 41 and the rear end 37 of the clamping sleeve 29. The outer diameter of the rear ring web 53 is constant in this respect and corresponds to the maximum outer diameter of the rear clamping section 41. In addition, the clamping sleeve 29 includes at its inner surface, which is otherwise formed at least substantially cylindrically, two ring webs 75 which each extend in the peripheral direction and project radially inwardly.

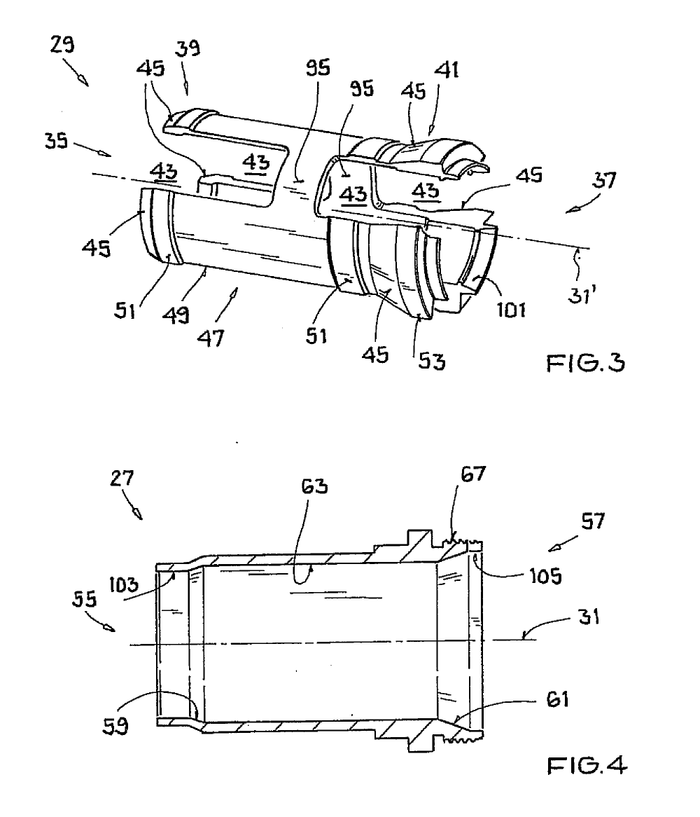

As can be seen from FIG. 4, the hub 27 has a front axial end 55, a rear axial end 57 and two contact sections 59, 61 which are arranged spaced apart from one another in the longitudinal direction 31 of the hub 27, with the mutual spacing of the two contact sections 59, 61 corresponding to the mutual spacing of the two clamping sections 39, 41 of the clamping sleeve 29. The contact sections 59, 61 each have an inner cross-section expanding conically toward the rear end 57 of the hub 27. The maximum inner cross-section of the rear contact section 61 is in this respect larger than the maximum inner cross-section of the front contact section 59.

The front contact section 59 of the hub 27 forms a counter-shape to the front clamping section 39 of the clamping sleeve 29; the rear contact section 61 of the hub 27 forms a counter-shape to the rear clamping section 41 of the clamping sleeve 29. The hub 27 is in each case formed cylindrically at the inner side between the two contact sections 59, 61, i.e. at a middle hub section 63, and from the respective contact section 59, 61 toward the respective end 55, 57.

The clamping sleeve 29 already pushed into the hub 27 and contacting the contact sections 59, 61 of the hub 27 with its clamping sections 39, 41 is axially loaded with force for the clamping of the steam leadthrough 15 in the hub 27 of the rotary drive 11 of the rotary evaporator 9. The front or rear clamping section 39, 41 of the clamping sleeve 29 in this respect runs onto the front or rear conical contact section 59, 61 of the hub 27, whereby the two clamping sections 39, 41 are urged radially inwardly and thus toward the steam leadthrough 15.

The axial force loading is provided by a clamping ring nut 65 (FIG. 2) which presses onto a ring shaped end face 69 formed at the rear end 37 of the clamping sleeve 29 and extending radially to the longitudinal axis 31. For this purpose, the clamping ring nut 65 includes an internal thread with which the clamping ring nut 65 is screwed onto the hub 27 whose rear end 57, at which an external thread 67 corresponding to the internal thread of the clamping ring nut 67 is formed, projects from the rotary drive 11. Clamping sleeve 29 is hereby axially clamped.

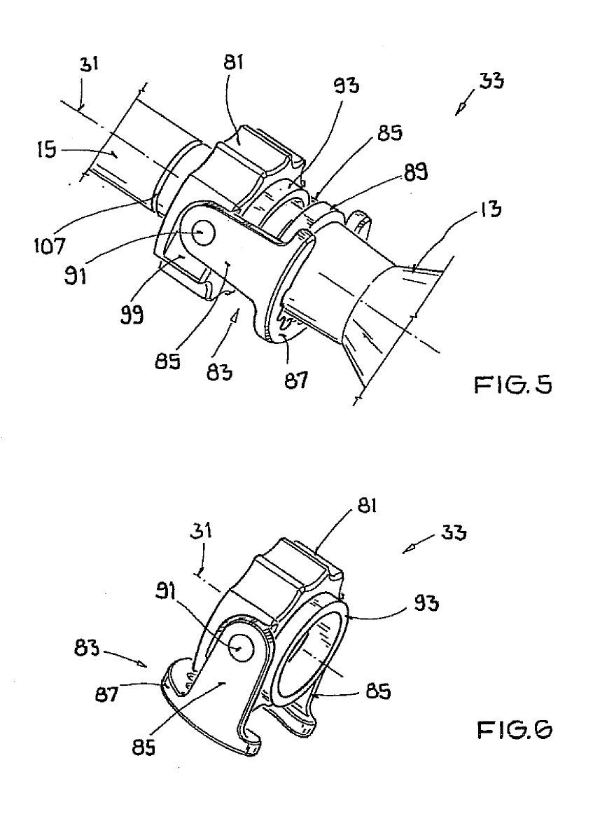

In the assembled state, the steam leadthrough 15 is clamped in the hub 27 by the clamping sleeve 29. It can in this respect be achieved by the openings 43 formed in the clamping sleeve 29 that the clamping sections 39, 41 can be compressed radially inwardly more easily. To define a relative axial alignment of the steam leadthrough 15 to the clamping sleeve 29, a peripheral web 97 is formed at the inner surface of the clamping sleeve 29 and engages into a groove 107 formed at the outer surface of the steam leadthrough 15 as a counter-shape (FIG. 5). A peripheral centering section 101 projects axially from the second rear end 37 of the clamping insert formed as a clamping sleeve 29; it is in particular formed in wedge shape, is in particular interrupted and is arranged in the assembled state of the clamping sleeve 29, viewed in the radial direction, between the steam leadthrough 15 and an outer wall section of the clamping ring nut 65.

A peripheral free space 71 is formed between the hub 27 and the clamping sleeve 29 in the middle region 47 of the clamping sleeve 29 due to the recess 49 which runs around there (FIG. 2b). A clamping sleeve 29 which swells up as a consequence of contact with distillate can expand into the free space 71 without a fixing of the steam leadthrough 15 in the hub 27 necessarily occurring here. This also applies in another respect to a free space 73 which is formed in the axial direction between the two ring webs 75 and in the radial direction between the clamping sleeve 29 and the steam leadthrough 15.

A good centration of the steam leadthrough 15 in the hub 27 of the rotary drive 11 of the rotary evaporator 9 and thus a good true running of the steam leadthrough 15 can be achieved by the clamping sleeve 29 with its two clamping sections 39, 41 and the hub 27 formed in counter-shape thereto and having the two contact sections 59, 61. This is in particular of advantage since a sealing ring 77 which is provided close to the front clamping section 39 and which is arranged between the steam leadthrough 15 rotating in operation and a cooler connection 79 of the stationary cooler 17 is hardly loaded in this respect. The sealing ring 77 consequently has a high operating life. Furthermore, the contact surfaces between the steam leadthrough 15 and the clamping sleeve 29 and between the clamping sleeve 29 and the hub 27 can be minimized by the clamping sleeve 29.

The ground clamp 33 releasably connectable to the apparatus is shown in more detail in FIGS. 5 and 6 and includes at the ground core side, i.e. at its side facing the steam leadthrough 15, a ring nut 81 and at the ground sleeve side, i.e. at its side facing the evaporator flask 13, a clamp connector 83. The ground clamp 33 is shown together with the steam leadthrough 15 and the evaporator flask 13 in FIG. 5. For reasons of clarity, the clamping ring nut 65 is omitted in FIG. 5. The ground clamp 33 is shown in an individual representation in FIG. 6.

The ring nut 81 has an internal thread with which the ring nut 81 can be screwed onto an external thread of the aforesaid clamping ring nut 65. The ground clamp 33 can be attached or fastened secure against losing at the hub 27 of the rotary drive 11 of the rotary evaporator 9 via the ring nut 81—in particular under the agency of the aforesaid clamping ring nut 65. To facilitate a screw rotation of the ring nut 81, it—just like the clamping ring nut 65—is provided with a gripping corrugation at its outer surface.

The at least substantially hoop-shaped snap connector 83 is pivotably and centrally supported at the ring nut 81. The snap connector 83 includes two pivot arms 85 which are each pivotally connected to one of two sides of the ring nut 81 disposed diametrically opposite one another with respect to the longitudinal axis and/or the axis of rotation of the ring nut 81. The snap connector 83 furthermore includes a holding section 87 of partly ring shape. The snap connector 83 is pivotable between a holding position shown in FIGS. 1, 2 and 5 and securing the ground joint and a release position shown in FIG. 6.

The ring nut 81 and the snap connector 83 are each formed in one piece and from plastic. To form the ground clamp 33 and the pivotable support of the snap connector 83 at the ring nut 81, the snap connector 83 is latched via openings formed in the pivot arms 85 to pivot spigots 91 formed at the two diametrically opposed sides of the at the ring nut 81. The pivot range of the snap connector 83 amounts to approximately 90° and is bounded by the opening angle of a pivot recess 99 associated with the respective pivot arm 83.

The holding section 87 of part circle shape 87 is formed open at that side which runs ahead on a pivoting of the snap connector 83 from the release position into the holding position. As can be recognized from FIG. 2a, a plane is defined by the holding section 87 which extends at least substantially perpendicular to the longitudinal axis and/or the axis of rotation of the ring nut 81 in the holding position of the snap connector 83.

In the holding position, the holding section 87 of the snap connector 83 engages behind a flanged rim 89 formed at the ground sleeve of the evaporator flask 13 and snaps into the ground sleeve of the evaporator flask 13. To ensure a snapping in, the holding section 87 of part circle shape extends over a circle arc of more than 180° and is formed sufficiently spring elastically deformably at least the two ends of the part circle. The evaporator flask 13 is held by form fitting by the snap connector 83 in the holding position. The evaporator flask 13 can in particular also be held by the snap connector 83 when the snap connector 83 is no longer completely screwed onto the clamping ring nut 65.

In the release position in accordance with FIG. 6, the snap connector 83 is pivoted away from the longitudinal axis and/or the axis of rotation of the ring nut 81 by approximately 90° with respect to the holding position shown in FIGS. 1, 2 and 5 to release the flask neck and thus the evaporator flask 13.

The ring nut 81 furthermore has a prolongation which extends in the direction of the evaporator flask 13 and which is formed as a press-off section 93. If the ground joint which is not (no longer) secured can no longer be released, i.e. if the evaporator flask 13 can no longer be pulled off the steam leadthrough 15, a pressing off of the evaporator flask 13 can be achieved by unscrewing the ground clamp 33 or the ring nut 81 from the clamping ring nut 65.

A reliable and simple securing of the ground joint between the steam leadthrough 15 and the evaporator flask 13 can be achieved by the ground clamp 33. Deviations in the diameter of the ground sleeve and/or of the flask neck of the evaporator flask 13 from a standard diameter or from an expected diameter can be tolerated and have no return effect on the fastening of the ring nut 81 at the clamping ring nut 65 or at the rotary drive 11.

1. A rotary evaporator having an apparatus (33) for the securing of a ground joint including a ground sleeve and a ground core between an evaporator flask (13) and a steam leadthrough (15),
characterized in that
the securing device (33) has a fastening section (81) at the ground core side and a snap connector (83) at the ground sleeve side and pivotably supported at the fastening section (81) between a release position and a holding position in order selectively to release or firmly hold the piece of laboratory equipment (13) at the ground sleeve side.

2. A rotary evaporator in accordance with claim 1, characterized in that the fastening section (81) is designed as a ring nut, in particular having an internal thread.

3. A rotary evaporator in accordance with claim 2, characterized in that the ring nut (81) can be screwed onto an external thread of a component (65) through which the piece of laboratory equipment (15), in particular the steam leadthrough (15), at the ground core side, can be led, in particular of a clamping member (65) for the clamping of a clamping insert (29) for the clamping of the steam leadthrough (15) in a hub (27) of a rotary drive (11) of the rotary evaporator (9), or of the piece of laboratory equipment (15) at the ground core side.

4. A rotary evaporator in accordance with claim 1, characterized in that the clamp connector (83) has two pivot arms (85) which are each pivotally connected to the fastening section (81) at one of two sides of the fastening section (81) opposite one another, in particular diametrically opposite one another.

5. A rotary evaporator in accordance with claim 1, characterized in that the snap connector (38) includes a holding section (87) which is adapted to engage behind a flanged rim (89) of the piece of laboratory equipment (13) at the ground sleeve side in the holding position of the snap connector (83).

6. A rotary evaporator in accordance with claim 5, characterized in that the holding section (87) of the snap connector (83) is designed in part ring shape with a circle arc extending over more than 180°.

7. A rotary evaporator in accordance with claim 5, characterized in that the holding section (87) is designed as spring elastically deformable.

8. A rotary evaporator in accordance with claim 5, characterized in that the holding section (87) defines a plane which extends at least substantially perpendicular to a longitudinal axis and/or to an axis of rotation of the fastening section (81) in the holding position of the snap connector (83).

9. A rotary evaporator in accordance with claim 1, characterized in that the pivot axis of the snap connector (83) centrally passes through the fastening section (81).

10. A rotary evaporator in accordance with claim 1, characterized in that the pivot range of the snap connector (83) has a value between 60° and 120°, with the value preferably amounting to at least substantially 90°.

11. A rotary evaporator in accordance with claim 1, characterized in that fastening section (81) has a press-off section (93) and/or press-off mechanism by which the piece of laboratory equipment (13) at the ground sleeve side can be pressed off the piece of laboratory equipment (15) at the ground core side.

12. A rotary evaporator in accordance with claim 1, characterized in that a gripping corrugation is provided at the outer side of the fastening section (81).

13. A rotary evaporator in accordance with claim 1, characterized in that the fastening section (81) and the snap connector (83) are each made in one piece and/or from plastic.

14. A rotary evaporator in accordance with claim 1, characterized in that a clamping member (65) for the clamping of a clamping insert (29) for the clamping of the steam leadthrough (15) in a hub (27) of a rotary drive (11) of the rotary evaporator (9) is provided, with the securing apparatus (33) being fastenable to the clamping member (65) and the clamping member (65) being fastenable to a rotary drive (11) of the rotary evaporator (9).

15. An apparatus for the securing of a ground connection including a ground sleeve and a ground core between two pieces of laboratory equipment (13, 15), in particular between an evaporator flask (13) and a steam leadthrough (15) of a rotary evaporator (9),
characterized in that
the securing device (33) has a fastening section (81) at the ground core side and a snap connector (83) at the ground sleeve side and pivotably supported at the fastening section (81) between a release position and a holding position in order selectively to release or firmly hold the piece of laboratory equipment (13) at the ground sleeve side.
